(19) United States
(12) Patent Application Publication
(10) Pub. No.: US 2019/0349624 A1
(43) Pub. Date: Nov. 14, 2019

(54) METHOD AND SYSTEM FOR SYNCHRONISING A REFERENCE AUDIO-VISUAL CONTENT WITH AN ALTERED VERSION OF THAT CONTENT BROADCASTED THROUGH TELEVISION DESCRIPTION

(71) Applicant: Tagsonomy, S.L., Llanera (ASTURIAS) (ES)

(72) Inventors: Luis Ignacio RODRÍGUEZ SOLÍS, Asturias (ES); Pablo PÉREZ GALLEGO, Asturias (ES); Guillermo MENÉNDEZ CORRAL, Asturias (ES); David FIERRO IGLESIAS, Asturias (ES)

(21) Appl. No.: 16/310,335

(22) PCT Filed: Jun. 14, 2016
(86) PCT No.: PCT/ES2016/070448

§ 371 Date: Dec. 14, 2018

(51) Int. Cl. H04N 21/43; G06F 16/483; H04N 21/44; H04N 21/462; H04N 21/81; H04N 21/41

(52) U.S. Cl. CPC H04N 21/4307; G06F 16/483; H04N 21/4126; H04N 21/4622; H04N 21/812; H04N 21/44008

(57) ABSTRACT

The invention relates to a method intended to provide or collect additional information concerning the content of a broadcast. For this purpose, it is necessary to design a process for synchronising between a reference audiovisual content and an altered television broadcast version thereof. The method comprises the steps of: creating a fingerprint of the broadcast content by means of the real-time extraction of features of the image which correspond to a series of frames; parcelling the image, that is dividing the screen corresponding to a frame of the broadcast into smaller pieces or parcels; extracting the colour histogram corresponding to each parcelled piece; searching for significant points of the image of each frame analysed; detecting the advertisement broadcast period; and comparing the fingerprint created for the broadcast content with the fingerprint created for the reference content, to achieve a degree of coincidence or certainty or correspondence below a threshold.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from International PCT Patent Application No. PCT/ES2016/070448, filed Jun. 14, 2016 entitled, “METHOD AND SYSTEM FOR SYNCHRONISING BETWEEN AN ITEM OF REFERENCE AUDIOVISUAL CONTENT AND AN ALTERED TELEVISION BROADCAST VERSION THEREOF”, which is incorporated herein by reference in their entirety.

### OBJECT OF THE INVENTION

In the first place, the object of the present invention, as specified in the title, is a method for synchronising a reference audio-visual content with an altered version of that content broadcasted through television and, in the second place, a system for performing said synchronisation process.

The synchronisation between the content broadcast through television and the reference content makes it possible to show and obtain metadata or additional data to the images shown through television. I.e. the purpose is to have additional information about the images broadcast through television, from any viewing platform (tablet or smartphone, Smart TV, online video player, etc.) in real time and synchronised with the broadcast of the film or documentary.

The present invention is characterised in that it uses different algorithms, some of them adaptive or smart, in addition to some digital techniques, in a joint, synergistic manner, in order to obtain a high-security synchronisation.

Therefore, the present invention is framed within the field of digital techniques, in particular those related to the broadcasting of programmes.

### BACKGROUND OF THE INVENTION

In order to understand the proposed synchronisation method, it is necessary to know that the films that we view are a succession of a series of images per second, which is what creates the optical continuity effect.

The number of images per second, also known as refresh rate, or fps (frames per second), is the rate at which a device shows images called frames or photograms. The term is equally applied to films and video cameras, computer graphics and motion capture systems. The refresh rate is expressed in frames per second, or the acronym FPS.

The first silent films were shot with cameras that recorded only 15 images per second; as a result, when they were screened, generally at a higher speed, the characters' actions seemed to be much more accelerated. The frame rate progressively increased with time, to up to 22 frames per second, although in fact the final speed of the film could be varied even by the projectionist in the projection booth itself.

The addition of sound to films entailed the requirement to shoot images at a fixed rate of 24 frames per second in order to achieve uniformity of sound. The human ear is more sensitive than the eye, and increasing or reducing the speed of sound would not have gone unnoticed by spectators. The 24 frames per second rate has survived in time, such that even today it is used as a standard in cinematographic shootings and screenings, which gives films their particular cinematographic visual appearance.

Oftentimes, when viewing a film or a recorded broadcast, we would like to have additional information about what we are viewing; for example, data related to the objects or places shown (schedules, sales prices of different products, location, historical data, geographical data, how to get there, etc.); however, it is not needed immediately. It is also interesting to obtain data (opinions, wishes, messages, etc.) related to a specific aspect of the content.

Consequently, with the method proposed herein, we intend to provide additional information related to the content of a broadcast; to this end, it is necessary to design a process for synchronising a reference audio-visual content and an altered version of that content broadcasted through television, whereto a number of information fields have been added, by developing a method and an architecture or system such as the one described below, the essentiality whereof is specified in the first claim.

### DESCRIPTION OF THE INVENTION

The object of the present invention is a method for synchronising a reference audio-visual content and an altered version of that content broadcasted through television.

Reference audio-visual content is understood to mean the basic recorded and stored content that is to be synchronised, whereas, in general, the broadcast audio-visual content is an altered version of the reference content, due to the transformations that the reference image may have undergone (remasterings that alter the colour or the edges, including cuts of a part of the reference image (cropping), the existence of different versions of the same reference content which have had segments thereof added or deleted, and the possible difference in broadcasting speed between the reference content and the content broadcast through television.

In general, the necessary stages or steps to obtain said synchronisation are:
Creation, prior to the broadcast, of a trace of the reference content, where the necessary transformations of the reference content are performed.
Creation, in real time, of a trace of the broadcast content, where the necessary transformations of the broadcast content are performed.
Comparison between the trace created from the broadcast content and the trace created from the reference content until a certain degree of coincidence or certainty is achieved, within a threshold that may be fixed or adaptive.

The synchronisation algorithm takes different aspects into consideration; on the one hand, it is in charge of extracting the characteristics of the image corresponding to a series of frames; to this end, during the process of creating the traces of both the reference content and the broadcast content, the following actions are performed:
Partitioning of the image, i.e. the screen corresponding to a frame of the broadcast is divided into smaller pieces or partitions.
Extraction of the Colour histogram corresponding to each of the partitioned pieces, to obtain four partitioned colour histograms, one for red, another for blue, another for green, and, finally, one for grey.
Searching for significant points in the image of the frame whose characteristics are to be obtained, i.e. we are no longer searching for a colour analysis or histogram, but for the border shapes or points, or those that make the greatest difference.

Comparison between the characteristics of the image in each of the frames analysed and a frame of the reference content, in order to determine whether or not the image broadcast at a given time corresponds to the saved broadcast image; in this case, should there be metadata associated with the corresponding image, they would be shown on the users' screen.

The process should be able to determine whether or not the comparison between the two frames, that of the broadcast image and that of the reference, matches. Said match need not be full, since it is dependent upon various factors, such as the quality of the broadcast, the quality of the recorded broadcast or the quality of the film itself, the noise added to the image by the broadcaster, in the form of logos or messages, the transformations that the reference image may have undergone (remasterings that alter the colour or the edges, including cuts of a part of the reference image (cropping), the existence of different versions of the same reference content which have had segments thereof added or deleted, and the possible difference in broadcasting speed between the reference content and the content broadcast through television; therefore, a match is considered to exist when there is a given degree of certainty or the differences are within a threshold that, moreover, may be adaptive or smart, i.e. one which learns from the levels of certainty that may be achieved during the comparison or what may be considered to be a good or bad synchronisation of a broadcast frame with a given reference frame, where the degree of certainty required throughout the broadcast may be modified by changing the required threshold.

During this process of comparing frames, a browser window is used which is located around the time of the broadcast, preferably forwards, i.e. towards a subsequent time. The purpose is to extract the characteristics of the image from the frames corresponding to a given window dimension, in order not to have to recover the characteristics of the image from all the frames in the broadcast, but only those closest to the time of the broadcast.

The browser window may be adaptive, i.e. it need not have a fixed length, such that, as the degree of correspondence achieved in the comparison between the frames increases, the browser window may be reduced, whereas, if the degree of correspondence between the frames decreases, the length of the browser window increases. Thus, in the event that the degree of correspondence progressively decreases, the number of seconds browsed in the browser window doubles each time that the degree of correspondence decreases, to a pre-set maximum, and once the latter has been reached, the window moves forward until it finds once again a correspondence between the broadcast content and the reference content.

Another aspect to be considered in the synchronisation process is the extraction of the horizontal black bars, which in some broadcasts appear above and beneath the broadcast image in order to adjust different formats. The real-time method must be able to detect them and cut them, in order to determine what piece of the image must be cut and extract the characteristics of the image only from those parts that have comparable content.

In order to fulfil said purpose, the method takes advantage of three characteristics specific to these black bars: they are continuously static bands, for which reason they undergo no changes or motion; they are symmetric or almost symmetric bands located on the upper and lower ends of the content; and they are totally black; in this way, the width of the horizontal black bars may be detected.

Another key aspect is the automatic detection of the advertisement breaks (or pauses for other reasons) during the broadcasting of the content through television. To achieve such detection, the process is based on three elements:
The identification of the logo of the broadcasting channel, which is usually located at some of the corners of the broadcast, and is generally static. The algorithm detects its position and shape. The identification of the logo is very useful to detect the advertisement broadcasting period, since during the broadcasting of advertisements the logo disappears, and reappears when the broadcast resumes.
The identification of the black frames, which are usually three or four consecutive, completely black frames, which allow commercial channels to separate the broadcasting of a film or a programme from the advertisements.
The analysis of the degree of correspondence during the comparison between the frames, such that, when said degree of correspondence disruptively skyrockets, it is a clear indicator of the beginning of advertisements.

Detecting the moment when the broadcast resumes is more simple, since, in the comparison, the broadcast frames begin to look like the saved frames.

The system is very robust and reliable, and achieves synchronisation even in those situations wherein the broadcast content and the reference content are widely different. Specifically, in the case of:
Different broadcasting speeds, in frames per second, of the reference content and the broadcast content, adjusted to different international standards (PAL, NTSC, etc.).
Superimposed noise introduced by the broadcaster (logos, messages, etc.).
Modified versions with respect to the reference content (modified colour spectrum, softening of contours, partial cuts of the image, superimposed texts in different languages, etc.).
Extended or short versions of the reference content, due to the fact that some scenes have been added or deleted, they may contain alternative endings, etc.

Except as otherwise specified, all the technical and scientific elements used in the present specification have the meaning that is habitually understood by normal persons skilled in the art whereto this invention belongs. In the implementation of the present invention, similar or equivalent processes and materials to those described in the specification may be used.

Throughout the description and the claims, the word “comprises” and variants thereof are not intended to exclude other technical characteristics, additives, components or steps. For persons skilled in the art, other objects, advantages and characteristics of the invention will arise, partly from the description and partly from the implementation of the invention.

### DESCRIPTION OF THE FIGURES

In order to supplement the description being made, and to contribute to a better understanding of the characteristics of the invention, according to a preferred embodiment thereof, a set of drawings is attached to said description as an integral part thereof, where the following is represented for illustrative, non-limiting purposes:

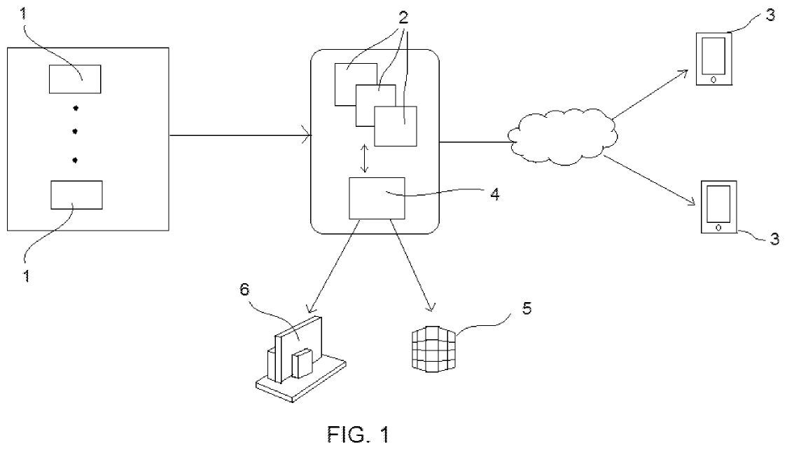

In FIG. 1, we may observe a representation of the architecture of the system designed to implement the method and the distribution of additional data in the synchronised broadcasts.

### PREFERRED EMBODIMENT OF THE INVENTION

In light of the FIGURES, below we describe a preferred embodiment of the proposed invention.

In FIG. 1, we may observe that the architecture of the system that allows for the synchronisation and distribution of additional information or data or metadata related to a live broadcast of a film, series or documentary towards a number of terminals, comprises:
A series of television receivers (1), designed to synchronise the reference content with the Television broadcast, by notifying of the current indicator and status of each of the channels synchronised by means of HTTP requests, and distribute them to all the synchronisation servers.
A series of synchronisation servers (2) connected to the groups of television tuners (1), which concentrate the different synchronisation signals received from them and redistribute the relevant updates towards the devices (3) connected thereto. Several synchronisation servers may be run in the same machine, listening to connections from different devices or ports. The number of devices (3) supported is scalable, by launching new instances.
A series of synchronisation monitors (4) that control the execution of the synchronisation servers (2), by periodically storing the status thereof in a table (5) and updating it in the cloud (6).

### SUMMARY

Having sufficiently described the nature of the present invention, as well as the way to implement it, we state that, within its essentiality, it may be implemented in other embodiments that may differ in some details from the one described as an example, and which will equally receive the protection being requested, provided that they do not alter, change or modify the fundamental principle thereof.

Method designed to provide or collect additional information related to the content of a broadcast, which requires designing a process for synchronising a reference audio-visual content with an altered version of that content broadcasted through television, where the method comprises the following steps:
Creation of a trace of the broadcast content by means of the real-time extraction of the characteristics of the image corresponding to a series of frames, by performing the following:
   Partitioning of the image, i.e. the screen corresponding to a frame of the broadcast is divided into smaller pieces or partitions.
   Extraction of the colour histogram corresponding to each of the partitioned pieces.
   Searching for significant points in the image of each of the frames analysed.
Detection of the advertisement broadcasting period.
Comparison between the trace created from the broadcast content and the trace created from the reference content until a certain degree of coincidence or certainty or correspondence is achieved, within a given threshold.

1. Method for synchronising a reference audio-visual content with an altered version thereof broadcast through television, comprising the following steps:
Creation, prior to the broadcast, of a trace of the reference content, where the necessary transformations of the reference content are performed.
Creation, in real time, of a trace of the broadcast content by extracting the characteristics of the image corresponding to a series of frames.
Where, in the process of creating the traces of both the reference content and the broadcast content, the following actions are performed:
Partitioning of the image, i.e. the screen corresponding to a frame of the broadcast is divided into smaller pieces or partitions.
Extraction of the Colour histogram corresponding to each of the partitioned pieces.
Searching for significant points (shapes or the boundary points) of the image in each of the frames analysed.
The method continues with the following steps:
Detection of the advertisement broadcasting period.
Comparison between the traces created from the broadcast content and the recorded content until a certain degree of coincidence or certainty or correspondence is achieved, within a given threshold.
Where
the number of frames wherefrom a trace of the content is created matches a browser window located around the time of broadcasting.
the browser window is adaptative, in such a way that the greater the degree of correspondence achieved when comparing the frames, the browser window may be reduced, while if the degree of correspondence between the frames decreases, the length of the browser window increases.
in the event that the degree of correspondence should progressively decrease, the number of seconds browsed in the browser window doubles each time that the degree of correspondence decreases, up to a configurable maximum and, once this maximum has been reached, the window commences a search in a forward direction until synchronisation is achieved.

2. Method for synchronising a reference audio-visual content and an altered version thereof broadcast through television, according to claim 1, wherein the number of frames analysed for the creation of the reference trace is one for every second of the reference content.

3. Method for synchronising a reference audio-visual content and an altered version thereof broadcast through television, according to claim 2, wherein the colour histograms obtained for each partitioned piece of each frame of the broadcast are histograms, one for the colour red, another for blue, another for green and, finally, one for grey.

4. Method for synchronising a reference audio-visual content and an altered version thereof broadcast through television comprising of the following steps:
Creation, prior to the broadcast, of a trace of the reference content, where the necessary transformations of the reference content are performed.
Creation, in real time, of a trace of the broadcast content by extracting the characteristics of the image corresponding to a series of frames.
Where, in the process of creating the traces of both the reference content and the broadcast content, the following actions are performed:
Partitioning of the image, i.e. the screen corresponding to a frame of the broadcast is divided into smaller pieces or partitions.
Extraction of the Colour histogram corresponding to each of the partitioned pieces.
Searching for significant points (shapes or the boundary points) of the image in each of the frames analysed.
The method continues with the following steps:
Detection of the advertisement broadcasting period.
Comparison between the traces created from the broadcast content and the recorded content until a certain degree of coincidence or certainty or correspondence is achieved, within a given threshold.
Where
the number of frames wherefrom a trace of the content is created matches a browser window located around the time of broadcasting.
the browser window is adaptative, in such a way that the greater the degree of correspondence achieved when comparing the frames, the browser window may be reduced, while if the degree of correspondence between the frames decreases, the length of the browser window increases.
in the event that the degree of correspondence should progressively decrease, the number of seconds browsed in the browser window doubles each time that the degree of correspondence decreases, up to a configurable maximum and, once this maximum has been reached, the window mences a search in a forward direction until synchronisation is achieved.
wherein the detection of the advertisement broadcasting periods is based on one or a combination of some of the methods described:
The identification of the logo of the broadcasting channel, since during the broadcasting of advertisements the logo disappears, and reappears when the broadcast resumes.
Identification of the black frames, which are usually three or four consecutive, completely black frames that allow commercial channels to separate the broadcasting of a film or a programme from the advertisements.
Analysis of the degree of correspondence during the comparison between the frames, such that, when said degree of correspondence disruptively skyrockets, it is a clear indicator of the beginning of advertisements.

5. Method for synchronising a reference audio-visual content and an altered version thereof broadcast through television, comprising of the following steps:
Creation, prior to the broadcast, of a trace of the reference content, where the necessary transformations of the reference content are performed.
Creation, in real time, of a trace of the broadcast content by extracting the characteristics of the image corresponding to a series of frames.
Where, in the process of creating the traces of both the reference content and the broadcast content, the following actions are performed:
Partitioning of the image, i.e. the screen corresponding to a frame of the broadcast is divided into smaller pieces or partitions.
Extraction of the Colour histogram corresponding to each of the partitioned pieces.
Searching for significant points (shapes or the boundary points) of the image in each of the frames analysed.
The method continues with the following steps:
Detection of the advertisement broadcasting period.
Comparison between the traces created from the broadcast content and the recorded content until a certain degree of coincidence or certainty or correspondence is achieved, within a given threshold.
Where
the number of frames wherefrom a trace of the content is created matches a browser window located around the time of broadcasting.
the browser window is adaptative, in such a way that the greater the degree of correspondence achieved when comparing the frames, the browser window may be reduced, while if the degree of correspondence between the frames decreases, the length of the browser window increases.
in the event that the degree of correspondence should progressively decrease, the number of seconds browsed in the browser window doubles each time that the degree of correspondence decreases, up to a configurable maximum and, once this maximum has been reached, the window commences a search in a forward direction until synchronisation is achieved.
wherein the threshold within which a correspondence between the broadcast frame and the recorded frame is considered to exist is adaptive or smart, which learns from the levels of certainty that may be achieved during the comparison or what may be considered to be a good or bad synchronisation of a broadcast frame with a given reference frame, where the degree of certainty required throughout the broadcast may be modified by changing the required threshold.

6. System that makes it possible to perform the synchronisation, and the distribution and collection of additional information or data or metadata related to a live broadcast towards or from a series of devices (3) according to claim 1, wherein it comprises:
A series of television tuners (1), designed to synchronise the television broadcast with the recorded or stored broadcast, by notifying of the current indicator and status of each of the channels synchronised by means of HTTP requests, and distribute them to all the synchronization servers.
A series of synchronisation servers (2) connected to the groups of television tuners (1), which concentrate the different synchronisation signals received from them and redistribute the relevant updates towards the devices (3) connected to each channel, maintaining these synchronised in real time.
A series of synchronisation monitors (4) that control the execution of the synchronisation servers (2), by periodically storing the status thereof in a table (5) and updating it in the cloud (6).
